(19) United States
(12) Patent Application Publication
(10) Pub. No.: US 2008/0311959 A1
(43) Pub. Date: Dec. 18, 2008

(54) Network device with display module

(75) Inventors: Ah-Jee Wang, Taipei City (TW); Troy Chen, Taipei City (TW)

Correspondence Address: BACON & THOMAS, PLLC, 625 SLATERS LANE, FOURTH FLOOR, ALEXANDRIA, VA, 22314-1176, US

(73) Assignee: D-Link Corporation, Taipei City (TW)

(21) Appl. No.: 11/878,482

(22) Filed: Jul. 25, 2007

(30) Foreign Application Priority Data
Jun. 15, 2007 (TW) 096121669

(51) Int. Cl. H04B 1/38

(52) U.S. Cl. 455/566

(57) ABSTRACT

In a network device with a display module, the display module is installed on a surface of a casing of the network device for displaying the status of the network device and the status of a network connection completely without requiring another external electronic device. After the network device has received various information on the network connection procedure of an external network connecting equipment, a network connecting device, and a final connection status and a self test status and outputted a control signal of the display module, each procedure and final information on the display module, the display module outputs a text, a graphic, or both text and graphic at the same time for user's viewing.

### FIELD OF THE INVENTION

The present invention relates to a network device, and more particularly to a network device with a display module.

### BACKGROUND OF THE INVENTION

As network and communication related technologies for networks, mobile communications and wireless communications are developed in an unprecedented speed and extended rapidly to every area of our life, the mode and method of using an electronic device encounter a revolutionary change accordingly. For instance, wireless network (Wireless LAN) is replacing cable network, since the wireless network has the following advantages:

1. Users can waive the installation of wires and cables and save the time of waiting for a technician to come over to their place for the installation.

2. As long as a user's electronic device comes with wireless network related equipments, the electronic device can be connected to a network within the transmission range of wireless network signals.

3. When users log on a network by a mobile electronic device (such as a notebook computer or a digital personal assistant), users are not restricted by the cables anymore and can freely change their position of using the mobile electronic device and continue the connection with the network regardless of their being at home or going out.

Obviously, the wireless network brings tremendous convenience to our life and work, and people have more chances of using wireless network devices now, and thus network device manufacturers keep on developing all kinds of high-performance, multifunctional wireless network devices to cope with market requirements and satisfy user's needs, and wireless network device has become an indispensable tool to the life and work of many people. However, the cable network devices or wireless network devices available in the market (as shown in FIG. 1) generally have the following shortcomings:

1. The connection statuses of a network device 10 and a network are indicated primarily by light signals of an light emitting diode (LED) 20, complemented with figures printed next to each corresponding light emitting diode on the casing 30, and thus only limited information is provided to users. For example, a lit LED indicates the connection status of a power supply, a system, an external network port (such as an Internet port), and an internal network port (such as a LAN port).

2. Since the Wi-Fi authentication organization has introduced the Wi-Fi protected setup (WPS) security authentication mechanism, information displayed by a network device becomes insufficient; particularly for the connection of a network device with the Internet involves connection protocol and authentication, users cannot have sufficient information on the status of error detection or setup by simply using the light signals to indicate the status of a succeeded or failed connection.

To fully understand the current status of a network device 10 and the status of a network connection, we usually need another electronic product (such as a desktop computer or a notebook computer) connected by cable or wireless transmission, a browser (such as IE or Netscape) or a dedicated software for displaying a network management screen of a network device and go over a series of operations to obtain various information. From the description above, present network devices cannot show the status of a network device and the status of a network connection completely by the light signals of a light emitting diode, but they require an external electronic product to show the status. Obviously, the present network devices require further improvements to show the status of a network device and the status of a network connection.

### SUMMARY OF THE INVENTION

In view of the foregoing shortcomings of the prior art, the inventor of the present invention based on years of experience in the related industry to conduct extensive researches and experiments, and finally developed a network device with a display module in accordance with the present invention to overcome the shortcomings of the prior art.

It is a primary objective of the present invention to provide a network device with a display module, wherein a display module is installed on a surface of a casing of the network device for showing the status of the network device and the status of a network connection completely without requiring another external electronic device, after the network device has received various information on the network connection procedure of an external network connecting equipment, a network connecting device, and final information and the status of a self test, and outputted a control signal of the display module, each procedure and final information on the display module, such that the display module can output a text, a graphic, or both text and graphic at the same time.

To make it easier for our examiner to understand the objective, technical characteristics and effects of the present invention, preferred embodiments will be described with accompanying drawings as follows;

### BRIEF DESCRIPTION OF THE DRAWINGS

FIG. 1 is a perspective view of a prior art network device;

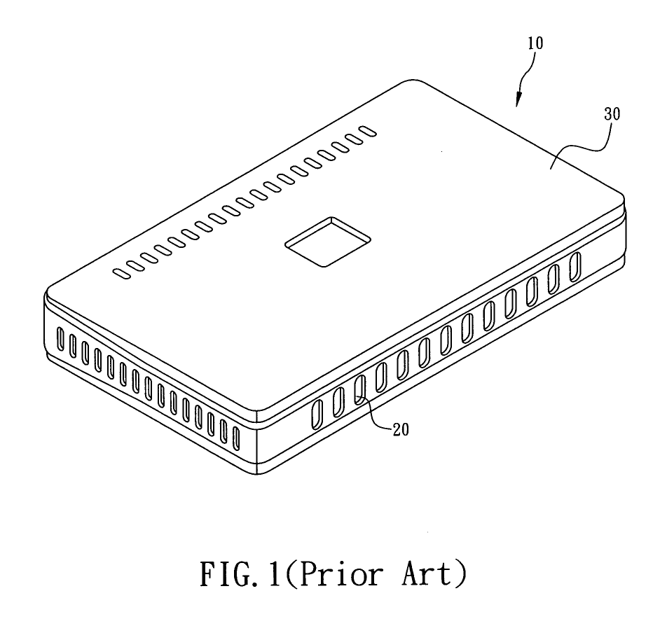

FIG. 2 is a perspective view of the present invention; and

FIG. 3 is a circuit block diagram of the present invention.

### DETAILED DESCRIPTION OF THE PREFERRED EMBODIMENTS

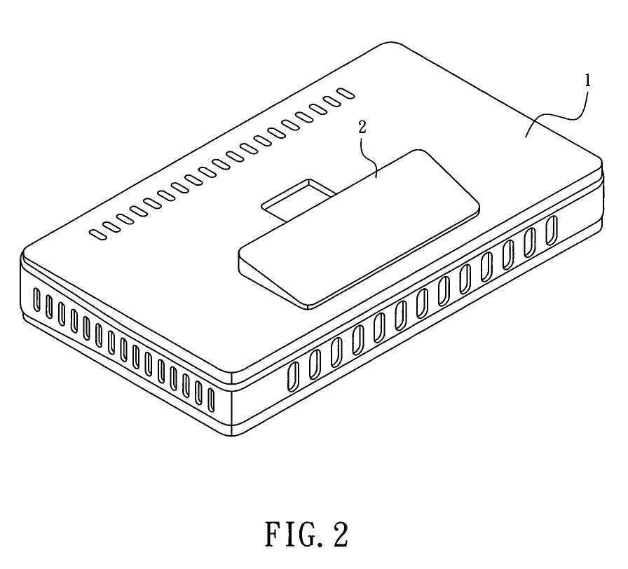

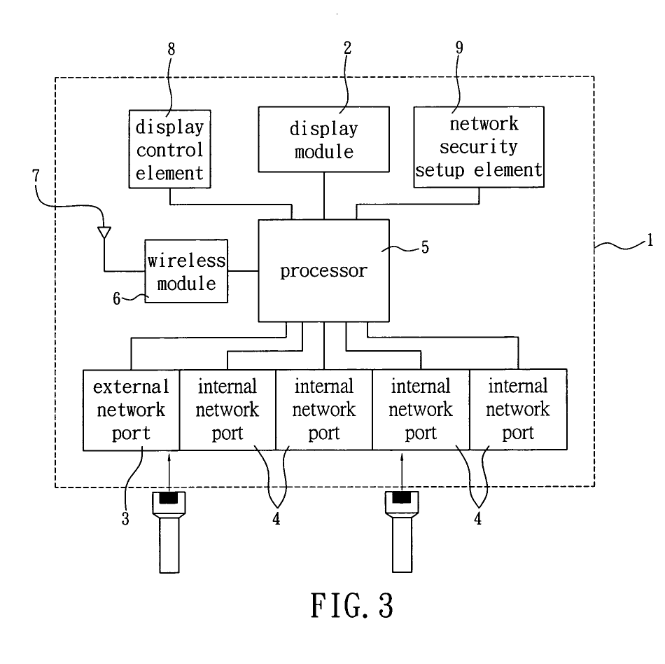

Referring to FIGS. 2 and 3 for a network device with a display module in accordance with the present invention, the network device comprises a casing 1, a display module 2 such as an organic light emitting display (OLED) installed on a surface of the casing, at least one external network port (such as a WAN port) 3 and at least one internal network port (such as a LAN port) 4 disposed on the casing 1 and proximate to one of the lateral sides of the display module, and a processor (such as a network processor) 5 installed in the casing and connected respectively to the display module 2, the external network port 3 and the internal network port 4. When the external network port 3 is connected to an external network connecting equipment (such as a xDSL/cable modem), or the internal network port 4 is connected to a network connecting device (such as a desktop computer a notebook computer or a digital personal assistant), the information of the status (after a network connection or a self test is completed) of a network connection procedure or a final connection, and a self test of the network device is provided, and the processor 5 sends a control signal and the status information to the display module 2, so that the display module 2 outputs a text, a graphic, or both text and graphic at the same time for showing the status information, and allowing user to know about the status of the network device and the status of the network in a quick, simple and effective way.

In a preferred embodiment of the present invention, the casing 1 further includes at least one wireless module 6 connected to the processor 5 and an end of an antenna 7 respectively, and another end of the antenna 7 is protruded out of the casing 1, such that the network device can transmit and receive a wireless network signal through the antenna 7.

In the preferred embodiment, a surface of the casing 1 further includes a display control element 8 (such as a press key) and a network security setup element 9 (such as a press key), wherein the display control element 8 and a network security setup element 9 are connected to the processor 5, so that the processor 5 receives a trigger signal generated when the display control element 8 is triggered, and turns on or off the display module 2 according to the trigger signal, so as to determine whether to turn on or off the display module 2, or send each status information to the display module 2 for an output. Further, the processor 5 receives a setup signal generated when the network security setup element 9 is triggered to start a network security setup procedure (WPS) preinstalled in the processor 5, and the processor 5 sends the setup information of the network security setup procedure to the display module 2 for an output, and allowing users to have the information on the processing status of the network security setup procedure.

With the assembly of the aforementioned components, the display module 2 of the present invention is installed on the network device, and integrated with the network security setup procedure of the network device or even with other procedures to improve the user's operating procedure of a network device (such as a SOHO router) and achieve the effects of providing a convenient application, reducing the error detection time of the network, and obtaining instant information. For a better understanding of the present invention, the following example is used for the illustration of outputting the status information by the display module when there is a change of network connection:

1. When the external network port 3 and the external network connecting equipment are connected (such as plugging in a network cable), the processor 5 of the network device detects a physical connection with the external network port 3 and controls the display module 2 to display information on an IP address assigned by the network device, a connection rate, a MAC address, a DNS, and a succeeded or failed connection according to the network connection mode of the external network connecting equipment.

2. When the internal network port 4 and a network connecting device (such as a computer) are connected, the network device generally assigns an IP address to the network connecting device as an identification data for the connected network between the network connecting device and the network device.

After the display control element 8 or the network security setup element 9 is triggered, the display module 2 outputs the status information:

1. After the display control element 8 is triggered, the processor 5 receives the trigger signal and issues a control command, so that the display module 2 displays the status information of a self test, status information of connecting an external network port 3 with a network, and the status information of connecting an internal network port 4, and issues a control command for turning on or off the display module 2.

2. After the network security setup element 9 is triggered, the processor 5 receives the setup signal, and issues a control command, so that the display module 2 displays the status information in a network connection procedure, and displays the status information of the final connection after the network connection status becomes stable (after a successful connection or a failed connection.

In summation of the description above, the invention installs the display module 2 on the network device, so that the network device can have the following functions:

1. Instantly displaying of the network status: if the network ports 3, 4 of the network device are plugged or unplugged, the display module 2 will display the status for a change of network connection.

2. Displaying the network setup status: If a user triggers the network security setup element 9 to start the network security setup procedure, the display module 2 will display the authentication procedure and the status of the result.

3. Providing a power-saving mode and a function of the display module 2: If a user triggers the display control element 8, the display module 2 will be switched to a power-saving mode for saving electric power and extend the life expectancy of the display module 2.

4. Automatically displaying an error message for a wrong connection: If the network ports 3, 4 fail to connect, the display module 2 will automatically display the status information for the failed connection to remind users to perform further error detection.

While the invention has been described by means of specific embodiments, numerous modifications and variations could be made thereto by those skilled in the art without departing from the scope and spirit of the invention set forth in the claims.

What is claimed is:

1. A network device with a display module, comprising:
a casing;
a display module, installed on a surface of the casing;
at least one external network port, disposed on the casing and proximate to one of the lateral sides of the display module;
at least one internal network port, disposed at a position of the casing proximate to the external network port; and
a processor, installed in the casing, and respectively connected to the display module, an external network port and an internal network port, for receiving a status information transmitted from the network ports, and transmitting and controlling a control signal of the display module and the status information to the display module, such that the display module outputs a text, a graphic, or both text and graphic at the same time to show the status information.

2. The network device as recited in claim 1, further includes at least one wireless module and an antenna respectively installed in the casing, wherein the wireless module is connected to the processor and an end of the antenna respectively, and another end of the antenna is protruded out of the casing, such that the network device can send and receive a wireless network signal through the antenna and the wireless module.

3. The network device as recited in claim 1, wherein the casing at its surface further comprises:
a display control element, connected to the processor, for generating a trigger signal when the display control element is triggered, and the trigger signal being received by the processor, such that the processor determines to turn on or off the display module according to the trigger signal, and determines whether or not each of the status information can be sent to the display module for an output; and
a network security setup element, connected to the processor, for generating a setup signal when the network security setup element is triggered, and starting a network security setup procedure preinstalled in the processor, and setup information of the network security setup procedure being sent from the processor to the display module for an output.

4. The network device as recited in claim 2, wherein the casing at its surface further comprises:
a display control element, connected to the processor, for generating a trigger signal when the display control element is triggered, and the trigger signal being received by the processor, such that the processor determines to turn on or off the display module according to the trigger signal, and determines whether or not each of the status information can be sent to the display module for an output; and
a network security setup element, connected to the processor, for generating a setup signal when the network security setup element is triggered, and starting a network security setup procedure preinstalled in the processor, and setup information of the network security setup procedure being sent from the processor to the display module for an output.
